(19) United States
(12) Patent Application Publication
(10) Pub. No.: US 2003/0081737 A1
(43) Pub. Date: May 1, 2003

(54) Voicemail system that stores text derived from DTMF tones

(76) Inventor: Martin DeGeorge, Cinnaminson, NJ (US)

Correspondence Address: RATNERPRESTIA, P O BOX 980, VALLEY FORGE, PA, 19482-0980, US

(21) Appl. No.: 10/021,426

(22) Filed: Oct. 30, 2001

(51) Int. Cl. H04M 1/64

(52) U.S. Cl. 379/67.1

(57) ABSTRACT

Apparatus for recording and replaying telephone audio messages containing DTMF tones includes a DTMF decoder that senses and decodes the DTMF tones into text and stores the text with the audio message in a storage device. The apparatus also includes a text-to-speech converter that converts the text representations of the DTMF tones to spoken words. The spoken words may replace the DTMF tones in the stored audio messages. The apparatus can initiate a telephone call by replaying the stored DTMF tones or by converting the stored text into DTMF tones. The apparatus is implemented as a part of a integrated receiver decoder (IRD) set-top box. A display device coupled to the IRD set-top box displays the text numbers while the audio messages are replayed using audio circuitry coupled to the set-top box.

### FIELD OF THE INVENTION

The present invention relates to the field of voice messaging systems and, in particular, voice messaging systems integrated with a set-top box for recording, displaying and transmitting dual tone multi-frequency (DTMF) tones.

### BACKGROUND OF THE INVENTION

Automated telephone answering systems are well known and in wide use in society today. Examples of such systems include stand-alone units that use cassette tapes or solid-state storage devices, central station units that are shared by a number of users, and more recently, units that are included with set-top boxes for cable and satellite video signal decoding.

Each of these systems can record an audio message from a caller, and can replay the message, on demand, to a user. Many times, however, the recorded audio message is not clear, and can not be understood by the user. The recording tape may be old, the telephone connection weak, or the caller may not properly enunciate his or her message. At these times, an important message, such as the preferred telephone number of the caller, may be lost or unintelligible.

One method of accurately recording a return phone number from a caller is by using a “Caller ID” system. This is a subscription service provided by a user's telephone service provider. In a Caller ID system, the phone number is transmitted, with the ring signal, to a user from the central station. The number may then be recorded by a Caller ID recording/display unit. Because the Caller ID information is typically stored separately from the message, it may be difficult to match the number recorded by the Caller-ID system with the message left by the caller on the answering machine. Also, not all phone numbers are displayed, as some phone numbers are displayed as “anonymous”, or “unavailable”, such as, if the caller has enabled a “Caller ID” blocking feature, or if the caller is calling from a business phone. Also, the caller may want to receive a return call at a different number than the number specified in the Caller ID message.

### SUMMARY OF THE INVENTION

The present invention is embodied in apparatus and method for recording and processing messages that include dual-tone multi-frequency (DTMF) tones on a telephone answering system. The apparatus includes a telephone answering machine unit for receiving messages, a DTMF tone decoder for converting the DTMF tones to text, and a storage device for storing the messages with the text corresponding to the DTMF tones.

According to one aspect of the invention, the apparatus includes text-to-speech conversion means which convert the stored DTMF tones to speech signals so that spoken words corresponding to the DTMF tones are replayed with the recorded message.

According to another aspect of the invention, the apparatus includes circuitry which stores the DTMF tones and, responsive to a command from a caller, provides the DTMF tones to a telecommunications system to initiate a telephone call.

According to yet another aspect of the invention, the apparatus is implemented in a integrated receiver/decoder (IRD) set-top box and the apparatus further includes processing circuitry that formats the stored text corresponding to the DTMF tones for display on a display device coupled to the IRD.

The method includes establishing a communications link between a caller and an answering machine unit and receiving a message from the caller. As part of the message, the caller may transmit DTMF tones, representing a return telephone number, using the caller's telephone keypad. The method recognizes the DTMF tones and converts them to text and stores the converted text with the audio message.

### BRIEF DESCRIPTION OF THE DRAWINGS

FIG. 1 is a high-level block diagram of an exemplary embodiment of the present invention.

FIG. 2 is a high-level block diagram of an exemplary embodiment of the telecommunications unit of the present invention.

FIG. 3 is a flow diagram of an exemplary embodiment of a method of recording a message of the present invention.

FIG. 4 is a flow diagram of an exemplary embodiment of a method of playback of messages of the present invention.

FIG. 5A, 5B and 5C are diagrams of exemplary message display screens.

### DETAILED DESCRIPTION

The present invention provides apparatus and method for easily and accurately recording and displaying a message containing a telephone number or other information contained in DTMF tones that are recorded by an automated telephone messaging system. The exemplary system may be built, for example, using industry standard components and is relatively easy to use by both a caller (the party leaving a message) and a user (the party retrieving the message).

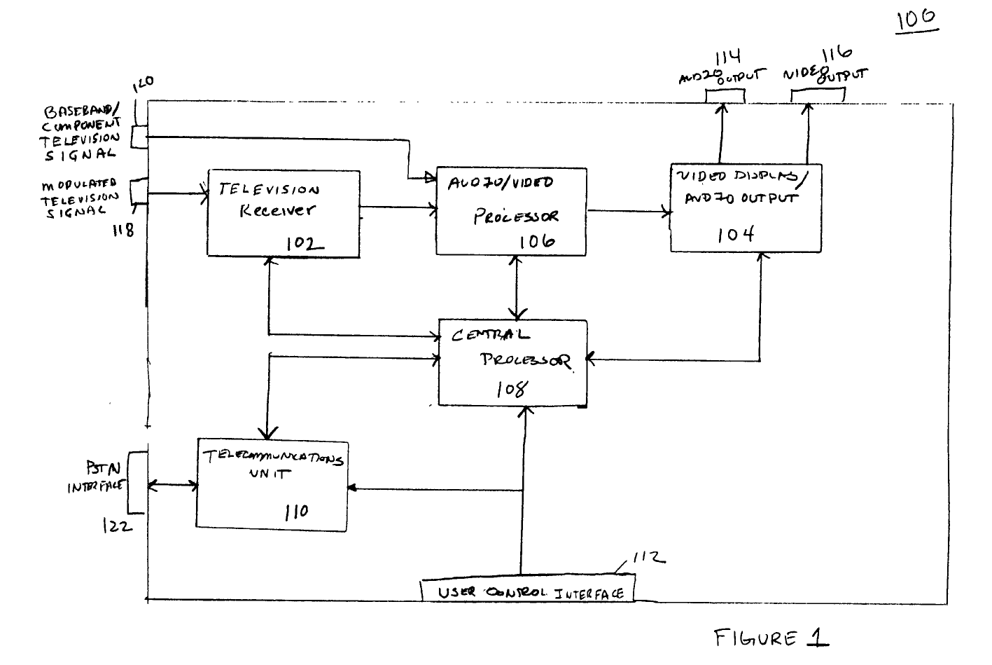

FIG. 1 shows a high-level block diagram of an exemplary embodiment of the present invention. Shown is a integrated receiver/decoder (IRD) set-top box 100, generally used for receiving and decoding terrestrial, cable and/or satellite television signals as well as prerecorded television signals, for example, from a digital versatile disc (DVD) system or personal video recorder, and providing the decoded signal to a television display device (not shown) and an associated audio reproduction device (not shown). A central processor 108 controls timing and other administrative functions within the set-top box 100. The set-top box 100 receives modulated television signals (i.e. terrestrial broadcast, cable or satellite signals) via an input terminal 118 and provides the modulated signals to a television receiver 120.

The receiver 120 may include, for example, circuitry used to demodulate digital and analog television signals that have been transmitted in any of a number of different standards such as Advanced Television Systems Committee (ATSC) signals, Digital Cable signals and signals that correspond to an analog standard such as the National Television Systems Committee (NTSC). When digital television signals are received, the receiver 102 demodulates the signals to recover a transport stream and decodes the transport stream into an elementary bit-stream or a sequence of packetized elementary stream (PES) packets. When an analog video signal is received, the receiver 102 may provide a baseband television signal or component video and audio signals.

The output signal of the television receiver 102 is applied to an audio/video processor 106. The processor 106 also receives baseband or component video signals from an input terminal 120. These signals may be, for example, prerecorded signals provided by a DVD player, analog video cassette recorder (VCR) or personal video recorder. The processor 106 may include, for example, a decoder that corresponds to the standard adopted by the Moving Picture Experts Group (MPEG) to convert the MPEG and ATSC television signals into decoded audio and video signals. It may also include a conventional analog decoder such as an NTSC decoder that converts a baseband NTSC signal into separate audio and video components. The output signals of the processor 106 are applied to video display/audio output circuitry 104.

The video display/audio output circuitry 104, which may include, for example, video down-conversion and matrixing circuitry and audio preamplifiers, formats the audio and video signals into formats suitable for reproduction by conventional audio amplification systems and video display monitors. The circuitry 104 may provide, for example, S-video signals or component video signals. It may also provide audio signals as six-channel surround-sound signals or standard stereo signals. This circuitry allows the set-top box 100 to be used with a variety of existing and new audio and video reproduction systems.

The set-top box 100 also includes a user control interface 112. This interface may be, for example, a control panel, an infrared receiver or a combination of both. In the exemplary embodiment of the invention, this interface allows the viewer to control the unit 100 using a standard infrared remote control unit.

The set-top box 100, as with many conventional top boxes, includes a telecommunications unit 110 to allow the viewer to interact with a supplier of video content. For example, commercially available satellite receivers requires a telephone connection for billing purposes. Many cable television systems require a telephone connection to order pay-per-view services. In the exemplary embodiment of the present invention, the telecommunication unit 110 is connected to a communications network typically through a Public Switched Telephone Network (PSTN) interface 122.

The television receiver 102, audio/video processor 106, video display/audio output circuitry 104, user control interface 112 and telecommunications unit 110 all are controlled by the control processor 108. For example, the processor 108 may cause the telecommunications unit to go off-hook or on-hook, to dial a stored number or to record an incoming message, as described below.

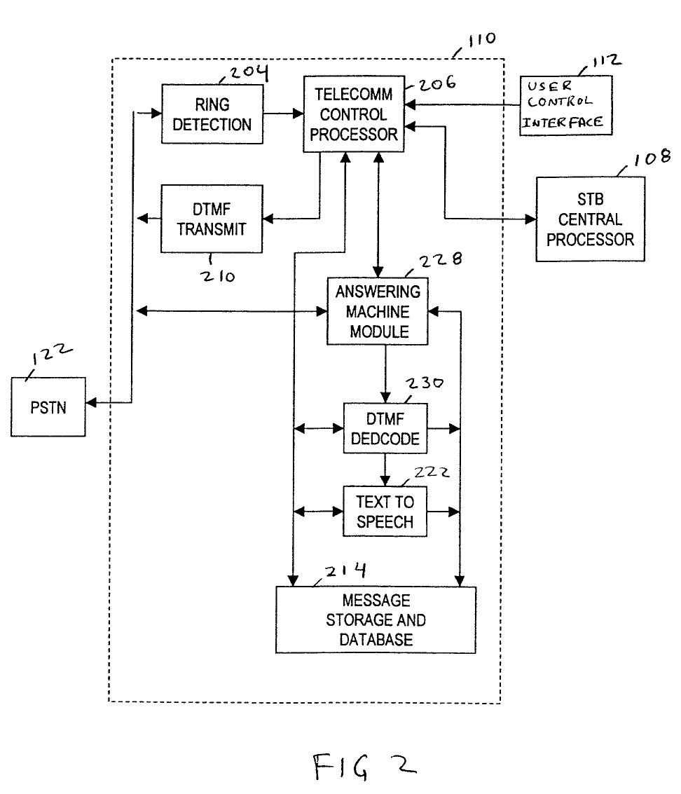

FIG. 2 shows a high-level block diagram of an exemplary embodiment of telecommunications unit 110. Telecomm control processor 206 controls, for example, all industry standard telephone functions within telecomm unit 110. Answering machine module 228 performs industry standard answering machine functions. When telephone control processor 206 receives a signal from the ring detection circuit 204, it places unit 110 in an off-hook condition so that the incoming telephone call may be answered by the answering machine module 228. The answering machine module 228, for example, can receive messages and play messages as required. In this exemplary embodiment of the present invention, answering machine module 228 plays a typical outgoing message (OGM) as well as receives and records incoming messages from a caller communicating to the telecomm unit 110 through PSTN 122. Unlike conventional answering machine modules, however, the module 228 is coupled to a dual tone multi-frequency (DTMF) decoder 230 which recognizes DTMF signals sent by a caller through PSTN 102. A caller may send such signals, for example, by pressing appropriate keys on the telephone keypad (not shown) after a connection has been made. Because the exemplary embodiment of the invention handles DTMF tones, it may be desirable to mention, in the OGM, that a caller may enter information using the telephone keypad.

Should a caller wish to leave a telephone number as a message, instead of or along with a voice message, the caller may simply press the appropriate keys on the caller's keypad (not shown) and the answering machine module 228 will record the DTMF tones generated by the keypad as a part of the audio message in the message storage memory 214. As the DTMF tones are stored into the memory 214, they are also decoded into numerical text by the DTMF decoder 230. The text representation of the DTMF tones may also be stored in the message memory 214 and associated with the recorded audio message. As the text representation of the DTMF tones are stored in memory 214, it may also be provided to text to speech processor 222 where the text numbers and symbols are converted into spoken words. The module 222 may, for example, read the text numbers from the memory 214 and generate corresponding phonemes to provide spoken versions of the numbers. These spoken words may also be stored in memory 214 and associated with the recorded audio message.

When the answering machine does not detect any DTMF tones in the message, the answering machine sends the message to message storage 214 as an audio only message.

If the text-to-speech module 222 provides spoken words representing the DTMF tones, the system may store the spoken words in place of the DTMF tones in the message. Thus, a caller may leave a message, “please call me at XXX-XXXX,” where each X corresponds to a DTMF tone and the system 110 may translate the message into “please call me at 555-1234.” When the spoken numbers replace the DTMF tones in the message, it may be desirable to separately record the DTMF tones or the text numbers represented by the tones for use in automatically placing a reply call to the person who left the message.

In an exemplary embodiment, both the audio message and the decoded DTMF tones can be presented simultaneously; the message can be played through the audio output port 114 while the text numbers representing the DTMF tones are displayed via the video output port 116. Each message, whether the message contains DTMF tones only, audio only, or a mix of DTMF tones and audio, is stored sequentially in message storage 214. The message storage 214 may be, for example, any industry standard mass storage device, such as a memory card or a magnetic disc.

The database portion of the memory 214 may contain names, phone numbers, addresses and other personal information relating to a user's personal contacts. This data may be entered by a user employing the user control interface 112 of the set-top box 100 (both shown in FIG. 1). Although they are shown as being combined, it is contemplated that the database may be separate from the memory 214.

When a message stored in the message storage 214 is linked to numerical text converted from DTMF tones, the text of the phone number can be compared with phone numbers stored in the database. If a match is found, the personal data associated with the phone number stored in database can be associated with the message stored in the message storage 214 for display to a user while the message is being played back.

Although the above description concerns only numbers and symbols resulting from a single key press of a telephone keypad, it is contemplated that the DTMF tones may also be translated into letters using conventional protocols for entering text using a telephone keypad. One such protocol translates a single press of a telephone key as the first letter represented by the key, two presses close in time as the second letter, and so on. Because the set-top box 100 may not know whether a particular sequence of key presses represents a sequence of numbers or a text message, an exemplary embodiment of the invention may allow the user to control the translation of the DTMF tones into either numbers or text. Thus, if during the playback of a message, the system displays a long string of numbers, the user may send a message to the set-top box 100 via the interface 112, that causes the processor 206 to convert the string of numbers into text and the provide the text to the text-to-speech processor 222. Thus, the text represented by the sequence of DTMF tones may be displayed using the video output port 116 or spoken to the user using the audio output port 114.

When a user of set-top box 100 wishes to replay the messages stored in message storage 214, the messages are retrieved from message storage memory 214 through the telecomm control processor 206 and the central processor 108 and processed through the audio/video display circuitry 104. Audio portions of the message are provided to the audio output port 114 and text is formatted and provided to the video output port 116. The formatted text information is displayed, for example, on an industry standard television video display (not shown) or computer display monitor device (not shown). Although shown as a single unit in FIG. 1, it is contemplated that the display circuitry may be separate from the audio processing circuitry.

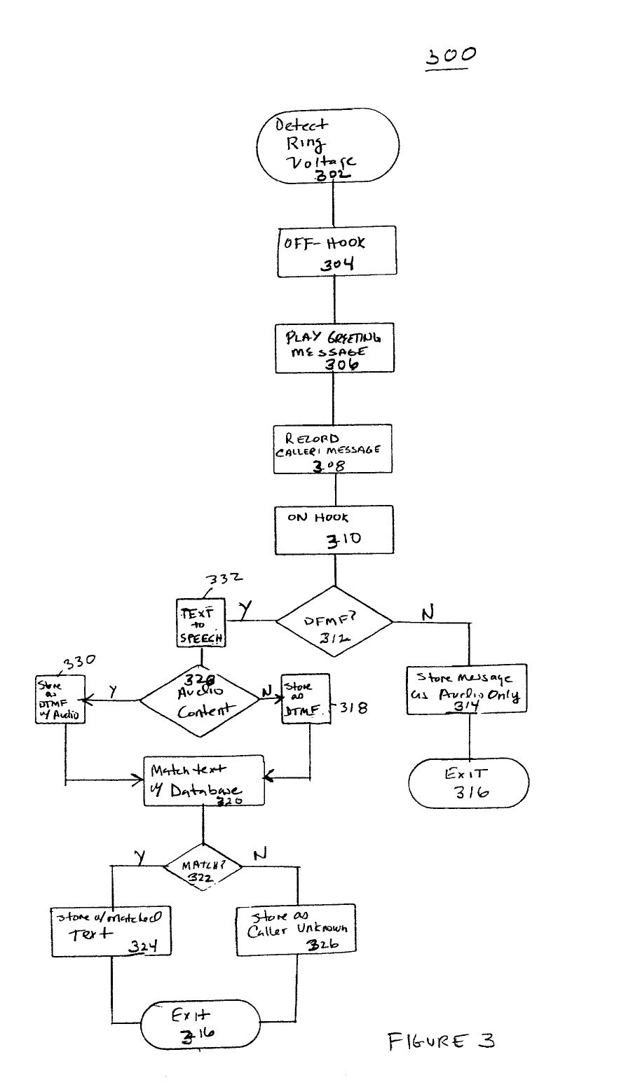

Turning now to FIG. 3, there is shown an exemplary embodiment of a method 300 of recording and storing messages according to the present invention. FIG. 3 is described with reference to FIGS. 1 and 2. At step 302, the ring detection circuit 204 of telecomm unit 110 detects a ring voltage coming from the PSTN interface 122. At step 304, telecomm controller 206 places the system off-hook and the incoming telephone call is answered. The controller 206 then causes answering machine module 228, at step 306, to play a greeting message. At step 308, the answering machine module 228 records the caller's message into message and storage database 214. Once the caller's message is recorded, the system goes back on hook at step 310 and the balance of the processing may be conducted while telecomm unit 110 is waiting for the next phone call.

While the message is being recorded, the DTMF decoder 230 is decoding any DTMF tones that may occur in the message. At step 312, the answering machine module 228 determines if the recorded message contains DTMF tones. If not, at step 314, the answering machine module 228 marks the stored message as being an audio only message. The process then ends at step 316 and waits for the next message.

If, at step 312, a DTMF tone is detected by the DTMF decoder 230, then, at step 332, the controller 206 passes the DTMF tones to the text-to-speech processor 222 to convert the text provided by the DTMF decoder into spoken words and stores the spoken words in the memory 214 linked to the message. The telecomm unit 110 also checks if the message contains non-DTMF audio data. If the message contains both DTMF tones and audio data, the message is marked at step 330 as a DTMF and audio message. Otherwise, at step 318 the telecomm unit 110 marks the message as a DTMF only message. In either case, the telecomm unit 110, at step 320, compares the phone number text data, provided by the DTMF decoder 230 to phone number text data contained in the caller database 212. If a match is found, at step 322, a link to the database entry for the number is added to the message stored in message storage 214. Telecomm unit 110 then exits method 300 at step 316.

As described above, in an alternative embodiment, the spoken words corresponding to the DTMF tones may replace the tones in the stored message. This may be implemented, for example, by the DTMF decoder 230 marking the message as it is stored into the memory 214 at the occurrence of each DTMF tone. The processor 206 may then overwrite the stored sound data for tones, based on the markings, with the spoken text corresponding to the numbers.

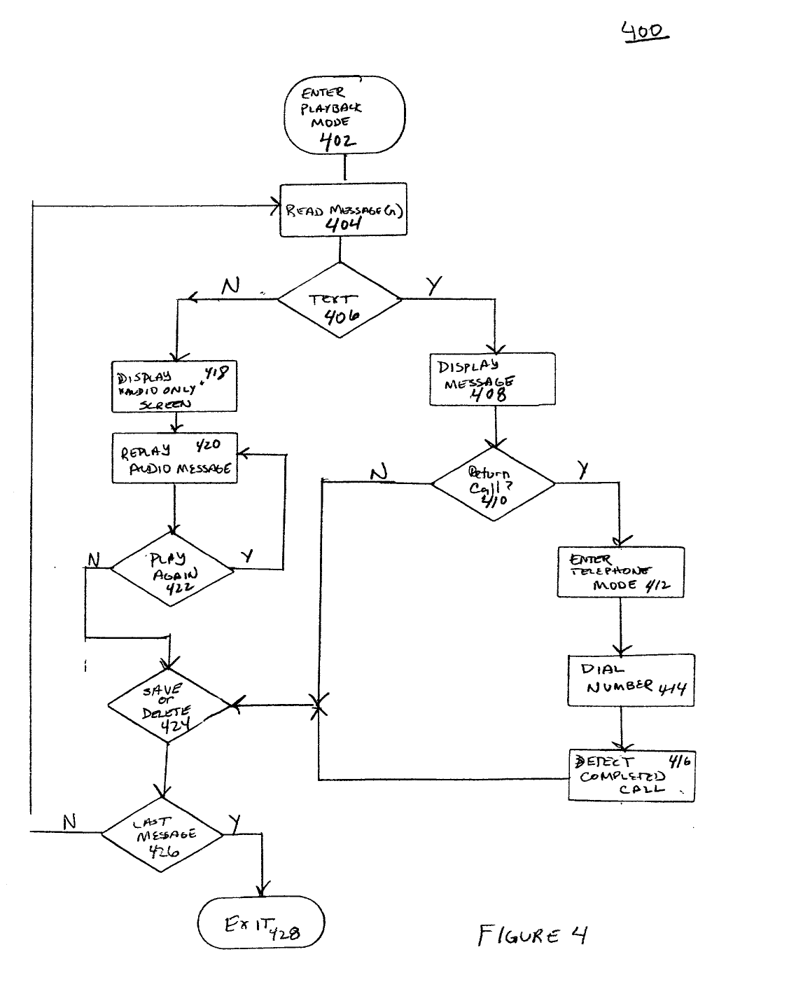

Turning now to FIG. 4 (also described with reference to FIGS. 1 and 2), there is shown a flow diagram of an exemplary embodiment of a playback method 400 of the present invention. At step 402 a user request, entered via the user control interface 112, causes the central processor 108 to place the telecomm unit 110 in playback mode. At step 404, the first message in the message queue residing in the message storage unit 214 is read by the telecomm processor 206 and provided to the central processor 108 and then to the video display/audio output circuitry 104. The system then determines if the message contains text at step 406. If the message does contain text, the central processor 108 causes the circuitry 104 to format and display the text message at step 408. Exemplary types of messages which can be displayed are discussed below.

As previously discussed, during playback of a message that includes DTMF tones, a prompt may be generated that asks a user to place a telephone call to the phone number contained in the message. Such a call may be placed by configuring the telecomm unit 110 to function as an industry standard telephone. If the user wishes to use the telecomm unit 110 to dial a telephone number, the user may place the system into telephone mode at step 412, wherein the telephone controller 206 instructs the DTMF transmitter 210 to generate the proper DTMF tones at step 414. These tones may be generated by the DTMF tone generator 210 responsive to the text version of the number extracted by the DTMF decoder or by simply playing back the audio version of the DTMF tones that are stored with the message. Once the call is completed at step 416, a prompt is generated that asks the user, at step 424, to save or delete the displayed message. The process then deletes the message or places the message back into the message storage unit 214 by saving the message. Next, at step 426 telecomm unit 110 detects if the last message has been played. If there are unplayed messages in message storage 214, telecomm unit 110 repeats method 400 from step 404 by retrieving the next message and continuing. Otherwise, method 400 exits at step 428.

If, at step 406, the process determines that the message does not contain text, the method continues to step 418 where a message, for example, “audio only” is displayed and the audio message is replayed at step 420. As this is an audio message, and audio only messages are commonly misunderstood for a variety of reasons, at step 422 of the exemplary embodiment, the user is prompted to replay the message. The message may be replayed as many times as the user wishes. Once the user has fully understood the audio message, the user may not wish to replay the message and will then be prompted to either save or delete the message at step 424. The process then continues as described above in reference to a message containing text.

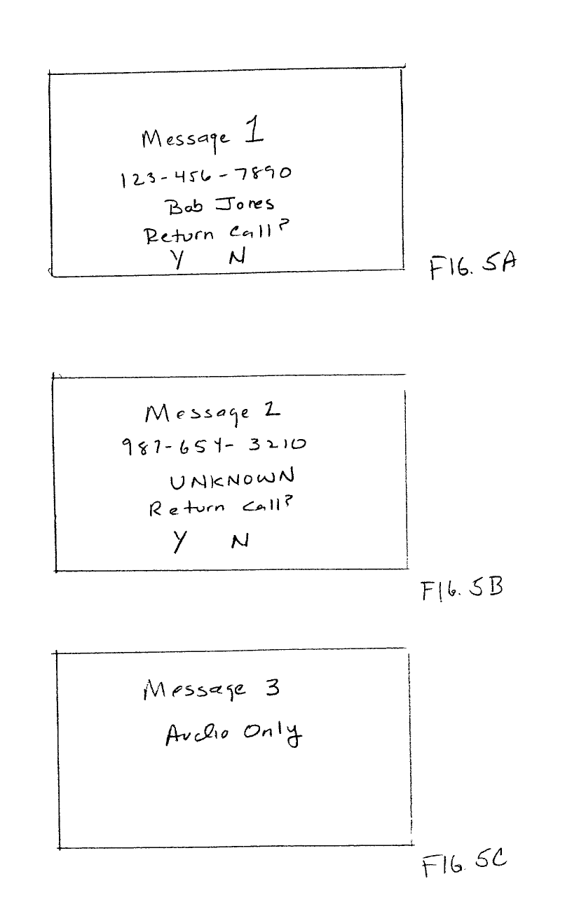

FIGS. 5A, 5B and 5C each illustrates an example of a displayed message. FIG. 5A illustrates an exemplary message used in the situation in which the caller has entered DTMF tones representing the caller's phone number. The DTMF tones are converted to text and the phone number text is matched with a known caller in the caller database 212. This message may then be displayed with the phone number, the caller's name, and any other personal data associated with the caller, such as address, company name, etc. Additionally, the message may prompt the user, with audio and/or text, to place a call to the phone number in the message. At this point, the user can decide to use the set top box 100 as a telephone with an automatic dialer in order to return the phone call to, in this case, Bob Jones. This message may also be presented to the user in audio form. The user may respond to the prompt, using, for example, a standard remote control device. When the call is placed through the set-top box 100, the set-top box may be configured as a conventional speaker phone using, for example, a compressor microphone and other audio processing circuitry (not shown) and the audio output circuitry to both receive voice signals and provide the caller's audio signals via the sound system connected to the audio output port 114. In another embodiment of the invention, the user may use voice commands which are interpreted by voice recognition software (not shown) residing in set-top box 100 to control telecomm unit 110.

FIG. 5B illustrates a message similar to that in FIG. 5A, except the phone number left by a caller has not been matched in the caller database 212. Therefore, the caller is displayed as unknown. The user is still given the opportunity to return the phone call to the displayed telephone number using the telephone feature in a set top box 100.

FIG. 5C is an exemplary embodiment of a message displayed when the recorded message contains only audio. This would occur when, as recited above, the caller does not enter any DTMF tones in the caller's message but leaves an audio message. The text of the message reads “audio only” and the audio message is broadcast through speakers to the user. In this case, the user has no ability to automatically return the phone call as the telecomm unit 110 cannot convert the message into usable data.

Although the invention has been described in terms of exemplary embodiments, it is contemplated that it may be practiced as described above within the scope of the attached claims.

What is claimed:

1. A telephone answering machine that records and presents audio messages which include dual-tone multi-frequency (DTMF) tones, comprising:
an answering machine module that receives the audio messages;
a DTMF tone decoder which converts the DTMF tones to text;
a storage device; and
a processor that stores the received audio messages and the text corresponding to the DTMF tones into the storage device.

2. A telephone answering machine according to claim 1, further including text-to-speech conversion means which converts the text to speech signals, wherein the processor stores the speech signals with the respective audio messages, corresponding to the text, in the storage device.

3. A telephone answering machine according to claim 2, wherein the processor is configured to store the speech signals in place of the DTMF tones in the respective audio messages in the storage device.

4. A telephone answering machine according to claim 1, wherein the DTMF tones are stored with the audio messages in the storage device and the telephone answering machine further includes:
a user interface, coupled to the processor for providing user commands to the processor; and
an interface to a public switched telephone network (PSTN); wherein the processor is responsive to a command provided via the user interface to retrieve the DTMF tones from the storage device and to provide the DTMF tones to the PSTN interface to initiate a telephone call.

5. A telephone answering machine according to claim 1, wherein the DTMF tones are stored with the audio messages in the storage device and the telephone answering machine further includes:
a user interface, coupled to the processor for providing user commands to the processor;
an interface to a public switched telephone network (PSTN); and
a DTMF tone generator configured to translate text numbers into DTMF tones and to provide the translated DTMF tones to the PSTN interface to initiate a telephone call;
wherein the processor is responsive to a command provided via the user interface to retrieve the text corresponding to the DTMF tones from the storage device and to provide the retrieved text to the DTMF tone generator.

6. A telephone answering machine according to claim 1, further including a display output port and an audio output port, whereby the stored audio messages are provided to the audio output port and the respective stored text is provided to the display output port for concurrent presentation to a user.

7. An integrated receiver/decoder (IRD) set-top box comprising,
video processing circuitry;
audio processing circuitry; and
a telecommunications unit, including:
an answering machine module that receives audio messages;
a DTMF tone decoder which converts DTMF tones in the received audio messages to text;
a storage device; and
a processor which stores the received audio messages and the text corresponding to the DTMF tones into the storage device, replays the stored messages using the audio processing circuitry and displays the text using the video processing circuitry.

8. An IRD set-top box according to claim 7, wherein the telecommunications unit further includes text-to-speech conversion means which converts the text to speech signals, wherein the processor stores the speech signals with the respective audio messages corresponding to the text in the storage device.

9. An IRD set-top box according to claim 8, wherein the processor is configured to store the speech signals in place of the DTMF tones in the respective audio messages in the storage device.

10. An IRD set-top box according to claim 7, wherein the DTMF tones are stored with the audio messages in the storage device and the telecommunications unit further includes:
a user interface, coupled to the processor for providing user commands to the processor; and
an interface to a public switched telephone network (PSTN); wherein the processor is responsive to a command provided via the user interface to retrieve the DTMF tones from the storage device and to provide the DTMF tones to the PSTN interface to initiate a telephone call.

11. An IRD set-top box according to claim 7, wherein the DTMF tones are stored with the audio messages in the storage device and the telephone answering machine further includes:
a user interface, coupled to the processor for providing user commands to the processor;
an interface to a public switched telephone network (PSTN); and
a DTMF tone generator configured to translate text numbers into DTMF tones and to provide the translated DTMF tones to the PSTN interface to initiate a telephone call;
wherein the processor is responsive to a command provided via the user interface to retrieve the text corresponding to the DTMF tones from the storage device and to provide the retrieved text to the DTMF tone generator.

12. An IRD set-top box according to claim 7, further including a display output port for providing for display video signals received by the IRD set-top box and an audio output port for presenting sound signals associated with the displayed video signals, whereby the stored audio messages are provided to the audio output port and the respective stored text is provided to the display output port for concurrent presentation to a user.

13. A method for processing telephone audio messages that include dual-tone multi-frequency (DTMF) tones, comprising the steps of:
receiving the telephone audio messages;
converting the DTMF tones to text; and
storing the received audio messages and the text corresponding to the DTMF tones into a storage device.

14. A method according to claim 13, further including the steps of:
converting the text to speech signals; and
storing the speech signals with the respective audio messages corresponding to the text in the storage device.

15. A method according to claim 14, wherein the step of storing the speech signals with the respective messages includes the step of storing the speech signals in place of the DTMF tones in the respective audio messages in the storage device.

16. A method according to claim 13, further including the step of initiating a telephone call by providing stored DTMF tones corresponding to one of the received audio messages to a telecommunications network.

17. A method according to claim 13, further including the step of
converting the stored text corresponding to one of the received audio messages to DTMF tones; and
initiating a telephone call by providing the converted DTMF tones to a telecommunications network.

18. A method according to claim 13, further including the steps of:
providing the audio messages as an audio output signal; and
displaying the stored text corresponding to each audio message as the respective audio message is provided.
